(19) United States
(12) Patent Application Publication
(10) Pub. No.: US 2007/0136115 A1
(43) Pub. Date: Jun. 14, 2007

(54) Statistical pattern recognition and analysis

(76) Inventors: Deniz Senturk Doganaksoy, Niskayuna, NY (US); Christina Ann LaComb, Schenectady, NY (US); Barbara Jean Vivier, Niskayuna, NY (US)

Correspondence Address: Patrick S. Yoder;FLETCHER YODER, P.O. Box 692289, Houston, TX, 77269-2289, US

(21) Appl. No.: 11/301,669

(22) Filed: Dec. 13, 2005

(51) Int. Cl. G06F 17/50

(52) U.S. Cl. 705/7

(57) ABSTRACT

A technique is provided for analyzing a dataset. The technique includes generating multivariate parameters to capture statistical patterns over time and/or across dimensions in the dataset, and developing a dynamic model based on the multivariate parameters for analyzing the dataset.

### BACKGROUND

The invention relates generally to statistical pattern recognition, and more specifically to detecting anomalies in a dataset based on the statistical pattern. In particular, the invention relates to monitoring financial health of a business entity based on the statistical patterns associated with the financial health of the business entity.

A wide variety of techniques are employed to analyze various datasets, such as financial datasets, demographic datasets, behavioral datasets or other datasets, for indications of events and patterns of interest. For example, in financial applications, financial datasets may be manually analyzed to identify anomalies for detecting potential fraud, risk assessment or for other purposes. Alternatively, computer implemented techniques may be employed for the analysis of such datasets. One of the popular computer implemented techniques of analyzing these datasets is to provide a model for representing the relationship between effect (sometimes referred to as results or conclusions, “Y”) and various parameters (e.g., inputs or factors that may influence the effect, sometimes referred to as “Xs”) contributing to that effect.

There are several commercially available tools that permit financial analysts to monitor the financial health of a business entity by analyzing many of the publicly available sources of financial information. These tools typically utilize quantitative financial information to generate risk scores indicative of the financial health of the business entity. Examples of quantitative financial data include financial statement reports, stock price and volume, credit and debt ratings and risk scores related to the business entity.

However, in traditional modeling approaches, various parameters (Xs) cannot be captured over time unless time itself is an important parameter (X) such as in time series modeling. Moreover, the relationships among various parameters (Xs) in detecting the anomaly (capturing the Y) may be represented only in limited ways such as in interaction effects or in ratios, such as financial ratios including leverage, and price-to-earnings ratios. Further, in modeling, the highest order of interactions that can be used is limited (typically at most three-way interactions) and the ratios usually capture only two variables at a time. For example, if time is not a major predictor, the parameters (Xs) used in statistical modeling are typically static parameters (Xs) that represent only one dimensionality or at most 3-4 dimensionalities (3-way or 4-way interactions) for a specific point in time. Additionally, in traditional company risk assessment, financial ratios try to capture the relationships between various parameters (Xs) such as parameters (Xs) for Altman's Z-score (working capital over total assets, retained earnings over total assets, earnings before tax over total assets, market value of equity over book value of total liabilities and sales over total assets) that are static in time (specific to the time/quarter where the user wants to do risk assessment).

Current business requirements are more in line with dynamic models that automatically adjust themselves over time (without manual validation and calibration) with changing economic and business environments. It is possible to create models where their coefficients automatically change over time. However, these types of models can never be fully dynamic when the Xs for those coefficients are static or, in other words, when those Xs capture only a specific characteristic at a very specific time period. Further, in situations where the dimensionality is high (i.e., many important Xs as is the case in company financials) and the Xs are changing over time, analytical capturing of X patterns is needed where patterns represent multiple dimensionalities across time with temporal effects (e.g., one X followed by another X in time).

For the example of company financials and modeling for credit scores, all earning measures, not just net income, are important since a company can potentially manipulate any of its measures to manipulate the financial statements (i.e., potential fraud). Similarly, a decline in company health cannot be limited only to rapid debt increase or to drop in cash flow from operations. In company risk assessment, all of the financial metrics are important. In addition, the signals of risk do not necessarily become apparent in the latest quarter. The performance in previous quarters in a company's life cycle is important as well in assessing risk. Moreover, relationships among Xs, such as cash flow from operations decreasing as net income is increasing, need to be captured as well.

Other more contemporary and advanced risk assessment techniques such as credit alert and financial anomaly detection partially attempt to capture the X patterns across dimensions over time. Credit alert scoring tries to capture not only the latest expected default frequency (EDF), which is one time point, but also the previous time period via the slope parameter for EDF. However, it does not capture multiple dimensions since it uses only EDF scores as the main X. Financial anomaly detection techniques try to capture the relationship, including the temporal relationship of Xs via red flags across multiple dimensions. However, the methodology used for capturing those patterns is rule-based, not statistical. Moreover, the across-time capturing of the Xs or red flags is done visually via “heat maps”, but such heat maps are not necessarily statistically quantified. The current techniques are, therefore, limited in capturing and analyzing the statistical patterns over time and across dimensions.

It is, therefore, desirable to provide an efficient technique for acquiring the statistical patterns over time and across dimensions and analyzing the acquired patterns for detecting anomalies, fraud and/or risk assessment.

### BRIEF DESCRIPTION

Briefly, in accordance with one aspect of the technique, a method is provided for capturing statistical patterns in a dataset. The method provides for representing time-varying and/or dimension-varying data in the dataset using statistics, and deriving multivariate parameters based on the statistical data. The multivariate parameters are indicative of statistical patterns in the dataset. Systems and computer programs that afford such functionality may be provided by the present technique.

In accordance with another aspect of the technique, a method is provided for analyzing a dataset. The method provides for generating multivariate parameters to capture statistical patterns over time and/or across dimensions in the dataset, and developing a dynamic model based on the multivariate parameters for analyzing the dataset. Here again, systems and computer programs affording such functionality may be provided by the present technique.

In accordance with another aspect of the technique, a method is provided for assessing financial health of a business entity. The method provides for acquiring patterns statistically over time and/or across dimensions. The patterns represent financial data and/or business data related to the business entity. The method also provides for developing a dynamic model based on the acquired patterns for analyzing financial and/or business data, and assessing financial health of the business entity based on the dynamic model. Here again, systems and computer programs affording such functionality may be provided by the present technique.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of a general-purpose computer system for capturing statistical patterns in a dataset and analyzing the dataset based on the captured statistical patterns in accordance with aspects of the present technique;

FIG. 2 is a flowchart depicting a process for capturing statistical patterns in a dataset in accordance with aspects of the present technique;

FIG. 3 illustrates examples for computing multivariate parameters via the process of FIG. 2; and

FIG. 4 is a flowchart depicting a process for analyzing a dataset in accordance with aspects of the present technique.

### DETAILED DESCRIPTION

The present techniques are generally directed to capturing statistical patterns and analyzing the statistical patterns for detecting anomalies. Such analytic techniques may be useful in evaluating a variety of datasets, such as financial datasets, demographic datasets, behavioral datasets, census datasets and so forth. Though the present discussion provides examples in context of financial dataset, one of ordinary skill in the art will readily apprehend that the application of these techniques in other contexts is well within the scope of the present techniques.

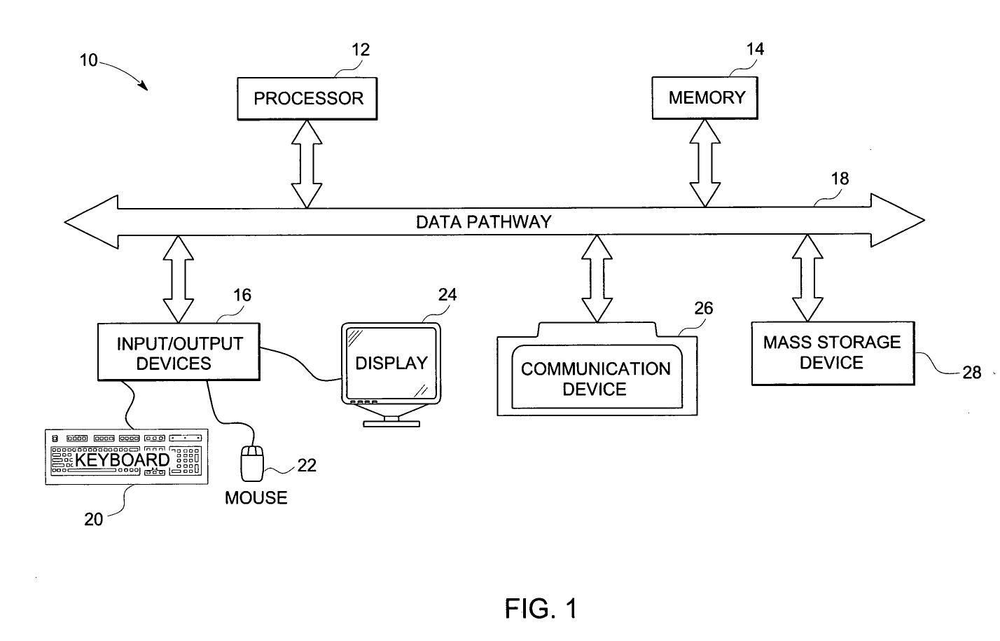

Referring now to FIG. 1, a schematic diagram of a general-purpose computer system 10 is illustrated in accordance with aspects of the present technique. The computer system 10 is configured to capture statistical patterns in a dataset and analyzing the dataset based on the captured statistical patterns. The computer system 10 generally includes a processor 12, a memory 14, and input/output devices 16 connected via a data pathway (e.g., buses) 18.

The processor 12 accepts instructions and data from the memory 14 and performs various data processing functions of the system, such as extracting data related to an entity from different information sources, capturing statistical patterns in the extracted dataset and performing analytics on the extracted data based on the statistical patterns. The processor 12 includes an arithmetic logic unit (ALU) that performs arithmetic and logical operations, and a control unit that extracts instructions from memory 14 and decodes and executes them, calling on the ALU when necessary. The memory 14 stores a variety of data computed by the various data processing functions of the system 10. The data may include, for example, quantitative and qualitative data, such as financial measures and ratios, commercially available financial rating scores, or business event information related to a business entity. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices 16, the data pathway 18, or in some other suitable manner.

The input/output devices 16 may further include a keyboard 20 and a mouse 22 that a user can use to enter data and instructions into the computer system 10. Additionally, a display 24 may be used to allow a user to see what the computer has accomplished. Other output devices may include a printer, plotter, synthesizer and speakers. The computer system 10 may further include a communication device 26 such as a telephone, cable or wireless modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN or a wide area network (WAN). The computer system 10 may also include a mass storage device 28 to allow the computer system 10 to retain large amounts of data permanently. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 may take the form of a hand-held digital computer, personal digital assistant computer, notebook computer, personal computer, workstation, mini-computer, mainframe computer or supercomputer.

As will be appreciated by one skilled in the art, the various datasets may be evaluated via a variety of analytical techniques. For example, the exemplary computer system 10 may acquire datasets, capture the statistical pattern in the datasets, and analyze the acquired datasets based on the statistical pattern by the techniques discussed herein. In particular, as will be appreciated by those of ordinary skill in the art, control logic and/or automated routines for performing the techniques and steps described herein may be implemented by the computer system 10, either by hardware, software, or combinations of hardware and software. For example, suitable code may be accessed and executed by the processor 12 to perform some or all of the techniques described herein. Similarly application specific integrated circuits (ASICs) configured to perform some or all of the techniques described herein may be included in the processor 12.

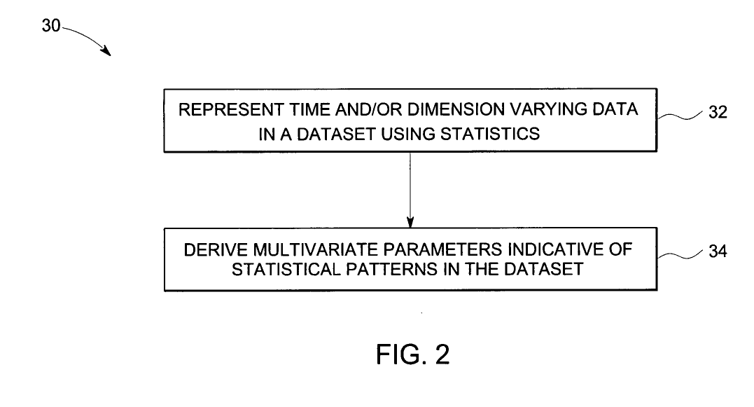

For example, referring now to FIG. 2, exemplary control logic 30 for capturing statistical patterns in a dataset via data analysis systems such as computer system 10 is depicted via a flowchart in accordance with aspects of the present technique. As illustrated in the flowchart, exemplary control logic 30 includes the steps of representing time-varying and/or dimension-varying data in the dataset using statistics at step 32, and deriving multivariate parameters based on the statistical data at step 34. The derived multivariate parameters are indicative of the statistical patterns in the dataset.

As will be appreciated by those skilled in the art, a series of analytical techniques may be employed to capture the patterns across time and across dimensions to be used as multivariate dynamic parameters (both time-varying and dimension-varying) in various applications such as in financial risk modeling. There are different ways of capturing these patterns statistically depending on whether the pattern is only time-varying or only dimension-varying or both. For example, a time-varying pattern across one dimension (e.g., net income, leverage, or ratio of slopes for cash flow from operations and net income) may be represented by moving averages across the desired number of consecutive time periods (e.g., quarters). Alternatively, the moving averages can be across non-consecutive time periods as well (e.g., to avoid seasonality effect, third quarters from the last 4 years can be used rather than 4 consecutive quarters). Moreover, moving averages may be replaced by moving medians, quartiles, standard deviations or any other statistic depending on what the proposed pattern is designed to capture over time.

Similarly, a dimension-varying pattern, such as all the earning measures (e.g., raw financials or modified Z-scores), at a specific time period (i.e., specific year and quarter), may be aggregated via central tendency (i.e., mean, median, mode) or variance (i.e., standard deviation, variance, quartiles, range) or Z-score (i.e., traditional Z-scores or modified Z-scores) measures. This aggregation may be performed on as little as two or on as many as all the financial metrics that are available for a company. Further, these dimension-varying patterns may also be performed on red flags or categorical measures that are rule-based and/or discrete quantities in terms of counts (e.g., how many “financial decline” red flags are triggered for that quarter/year), sums (e.g., what is the total number of modified Z-scores with a 6 or above cut-off across all the “money out” metrics in that quarter/year), or proportions (e.g., what is the proportion of number of red flags triggered for “misleading financials” to the number of non-missing cells across the same set of red flags for that specific quarter/year).

A time-varying and dimension-varying pattern is a combination of the above-described methodologies. Examples of such patterns would include, but are not limited to, the number of “misleading financials” red flags being triggered across the last three consecutive quarters; the third quartile of the distribution of modified Z-scores on all the earning measures for the last two years; the proportion of the number Z-scores above a 2-cut-off to the number of Z-scores below a 2-cut-off across debt; and total liabilities and total current liabilities metrics for the last 3 fourth quarters of a company.

A number of parameters may be used to compute the multivariate parameters. For example, the “TABLE 1” below lists a number of parameters in a financial dataset. Those skilled in the art of financial analysis will readily understand the meaning of the various parameters listed below, as well as their implications in financial analysis.

TABLE 1

| Field Name | Description | Field Name | Description |
|---|---|---|---|
| YEAR | Fiscal Year covered | QUARTER | Fiscal Quarter |
| | by financial | | covered by financial |
| | statement | | statement. Values |
| | | | are 1, 2, 3, 4 where |
| | | | 4 represents the |
| | | | annual filing. |
| MAXYEAR | Maximum Fiscal | MINYEAR | Minimum Fiscal |
| | Year | | Year |
| | covered | | covered |
| INV | Inventory | GI | Gross Intangibles |
| DEBT | Long Term Debt + | PPEN | Plant Property and |
| | Subordinated Debt | | Equipment Net |
| CCE | Cash and Cash | ADIS | Amortization and |
| | Equivalents | | Depreciation from |
| | | | IS |
| TOTE | Total Equity | OPEXP | Operating Expenses |
| TOTA | Total Assets | IE | Interest Expense |
| TOTCA | Total Current Assets | OPINC | Operating Income |
| TOTCL | Total Current | OI | Other Income |
| | Liabilities | | |
| TOTR | Total Revenue | COG | Cost of Goods Sold |
| TOTL | Total Liabilities | EXT | Extraordinary items |
| AP | Accounts Payable | EBT | Earnings before |
| | | | Taxes |
| AR | Accounts | CAPEX | Capital |
| | Receivable | | Expenditures |
| NI | Net Income | ACQ | Acquisitions |
| CFFF | Cash Flow from | CFFI | Cash Flow |
| | Financing | | from Investing |
| MAX_TOTR | TOTR for | CFFO | Cash Flow |
| | Maximum Fiscal | | from Operations |
| | Year | | |
| MAX_TOTA | TOTA for | MAX_NI | NI for Maximum |
| | Maximum Fiscal | | Fiscal Year |
| | Year | | |

A number of parameters may be derived based on the relationship between the above parameters. These parameters may be used in addition to the parameters above to compute the multivariate parameters. For example, the “TABLE 2” below lists a number of parameters derived from the parameters above. Those skilled in the art of financial analysis will readily understand the meaning of the derived parameters or ratios listed below as well as their implications in financial analysis.

TABLE 2

| Field Name | Description |
|---|---|
| GP | Gross Profit = TOTR − COG |
| OPINC | Operating Income = EBT + OI |
| EBITDA | Earnings before Interest, Taxes, Depreciation, and |
| | Amortization = EBT − ADIS − IE |
| CFFO_WO_NI | CFFO − NI |
| CFFO_WO_NI_TOTR | (CFFO − NI)/TOTR |
| ADJNI | NI − EXT |
| CFFO_WO_ADJNI | CFFO − ADJNI |
| CFFO_WO_ADJNI_ADJNI | (CFFO − ADJNI)/TOTR |
| DAYS_SALES_OUTS | Days Sales Outstanding: |
| | ((QUARTER*90)*AR)/TOTR |
| DEBT_ADJ | DEBT/TOTA |
| DEBT_ADJ_INTAN | DEBT/(TOTA − GI) |
| FCF | Free Cash Flow: CFFO + CAPEX |
| NI_TOTR | Net Profit Margin: NI/TOTR |
| OPINC_ADJ | OPINC/TOTA |
| OPINC_TOTR | Gross Profit Margin: OPINC/TOTR |
| PERIOD_COG_INV | Inventory Turnover: (2*COG)/(INV + INV_PRIOR), |
| | where INV_PRIOR is the INV value in the prior fiscal |
| | year/quarter |
| TOTL_ADJ_INTAN | TOTL/(TOTA − GI) |
| AR_GROWTH | (AR − AR_PRIOR)/ABS(AR_PRIOR), where |
| | AR_PRIOR is the AR value in the prior fiscal year/quarter |
| TOTR_GROWTH | (TOTR − TOTR_PRIOR)/ABS(TOTR_PRIOR), |
| | where TOTR_PRIOR is the TOTR value in the prior fiscal year/quarter |
| INV_GROWTH | (INV − INV_PRIOR)/ABS(INV_PRIOR), where |
| | INV_PRIOR is the INV value in the prior fiscal year/quarter |
| TOTL_ADJ | TOTL/TOTA |
| TOTCL_ADJ | TOTCL/TOTA |
| AP_ADJ | AP/TOTA |
| OPEXP_ADJ | OPEXP/TOTA |
| NI_ADJ | NI/TOTA |
| TOTR_ADJ | TOTR/TOTA |
| CFFO_ADJ | CFFO/TOTA |
| GP_ADJ | GP/TOTA |
| FCF_ADJ | FCF/TOTA |
| EBITDA_ADJ | EBITDA/TOTA |
| AR_ADJ | AR/TOTA |
| CCE_ADJ | CCE/TOTA |
| INV_ADJ | INV/TOTA |
| GI_ADJ | GI/TOTA |
| PPEN_ADJ | PPEN/TOTA |
| TOTE_ADJ | TOTE/TOTA |

Several multivariate parameters (red flags) may be formalized to identify companies with patterns of anomalies that are indicative of declining financial health or warning signs for misleading financials. A red flag or an alarm results from an anomalous value in a single metric (either high or low) when evaluated in comparison to the context. For example, when compared to its peers, a company's unusually slow collection of receivables could be used to trigger an alarm. Another example would be a significant decline in the sales volume for a company over time, represented by an anomaly-within score (discussed below) for the financial metric of total revenue being less than −2. This could be determined by calculating an anomaly-between score (discussed further below) for the target company for the financial metric of “days sales outstanding” and finding the resulting score to be greater than 2. An overall anomaly rating in one embodiment to a financial metric based upon the anomaly-within and anomaly-between scores for that metric.

In order to evaluate whether or not a given metric is an anomaly, an “anomaly score” for that financial metric for the target company can be calculated. The technical effect of calculating anomaly scores is to allow systems to objectively and automatically detect circumstances that can be used to identify financial data that indicate unhealthy or fraudulent finances at the target company. For a given target company, each financial metric can be analyzed to determine the degree to which the value for that metric is different from the appropriate context data for that company and that metric. Depending on the nature of the context used (i.e., over time as opposed to across an industry), there are two different types of anomaly scores that can be calculated: the “anomaly-within” score, and the “anomaly-between” score. “Anomaly-within” scores are scores calculated based upon the set of data representing a particular financial metric for a target company taken over different time periods. For instance, these data may represent financial metrics from successive fiscal quarters. The target value is generally the most recent value of the metric. In this way, anomaly-within scores measure a given company's financial data against its own past performance. Additionally, “anomaly-between” scores are scores based upon the set of data for a given financial metric taken for a target company and a group of peer companies, all for the same time period. These data may represent the performance of a group of similarly situated companies all considered in a particular fiscal quarter. The anomaly-between scores measure a given company's financial data against the performance of its peer group. One statistical technique to evaluate the degree to which a particular value in a group is an outlier, i.e. is anomalous, is to calculate a ‘Z-score’ for the value in the group. Typical Z-scores are based upon a calculation of the mean and the standard deviation of the group. Such anomaly score calculation techniques are described in co-pending U.S. patent application Ser. No. 11/022,402 entitled “Method and System for Anomaly Detection in Small Datasets” filed on 27 Dec. 2004, the entirety of which is hereby incorporated by reference herein.

The multivariate parameters are triggered either on a period-by-period basis or are defined by formal rules. For example, a multivariate parameter “RF_MARGINS_DEC” may be defined by the rule “Either NI_TOTR or OPINC_TOTR has a red Z-Within” and may indicate “a significant deterioration in margins”. In certain embodiments, the multivariate parameters are derived by computing the ratio of total number of metrics that exceed the negative threshold of the modified Z-scores across the given period of time and given set of metrics to the number of non-missing Z-scores across the given period of time and given set of metrics. In one embodiment, the negative threshold is set to less than or equal to −2 for Z-withins while the negative threshold is set to less than or equal to −1.5 for Z-betweens. The multivariate dynamic parameters may be, for example, MVA_OVERALL_{—}1 . . . 4 (overall), MVA_OVERALL_B1 . . . B4 (betweens only), MVA_OVERALL_W1 . . . W4 (withins only), MVA_OVERALL_E1 . . . E4 (earnings only), and MVA_OVERALL_D1 . . . D4 (debts only). Each of the multivariate dynamic parameters may include a number of variables such as those listed in the “TABLE 3” below.

TABLE 3

| | Types of | |
|---|---|---|
| Aggregate | Variables | Variables |
| MVA_OVERALL_1 | Overall | ADJNI_ZB3 |
| MVA_OVERALL_2 | | ADJNI_ZWAR_GROWTH_ZB3 |
| MVA_OVERALL_3 | | CAPEX_ZW |
| MVA_OVERALL_4 | | CFFI_ZW |
| | | CFFO_ZB3 |
| | | CFFO_ZW |
| | | EBT_ZB3 |
| | | EBT_ZW |
| | | FCF_ZB3 |
| | | FCF_ZW |
| | | GP_ADJ_ZB3 |
| | | GP_ZW |
| | | IE_ZB3 |
| | | IE_ZW |
| | | INV_ZW |
| | | NI_TOTR_ZB3 |
| | | NI_ZW |
| | | OI_ZB3 |
| | | OI_ZW |
| | | OPEXP_ZW |
| | | OPINC_TOTR_ZB3 |
| | | OPINC_ZW |
| | | TOTA_ZW |
| | | TOTCA_ZB3 |
| | | TOTCA_ZW |
| | | TOTCL_ADJ_ZW |
| | | TOTE_ADJ_ZB3 |
| | | TOTE_ADJ_ZW |
| | | TOTL_ADJ_ZB3 |
| | | TOTL_ZW |
| | | TOTR_ADJ_ZB3 |
| | | TOTR_ZW |
| MVA_OVERALL_B1 | Betweens | ADJNI_ZB3 |
| MVA_OVERALL_B2 | only | AR_GROWTH_ZB3 |
| MVA_OVERALL_B3 | | CFFO_ZB3 |
| MVA_OVERALL_B4 | | EBT_ZB3 |
| | | FCF_ZB3 |
| | | GP_ADJ_ZB3 |
| | | IE_ZB3 |
| | | NI_TOTR_ZB3 |
| | | NI_ZW |
| | | OI_ZB3 |
| | | OPINC_TOTR_ZB3 |
| | | TOTCA_ZB3 |
| | | TOTE_ADJ_ZB3 |
| | | TOTL_ADJ_ZB3 |
| | | TOTR_ADJ_ZB3 |
| MVA_OVERALL_W1 | Withins | ADJNI_ZW |
| MVA_OVERALL_W2 | only | CAPEX_ZW |
| MVA_OVERALL_W3 | | CFFI_ZW |
| MVA_OVERALL_W4 | | CFFO_ZW |
| | | EBT_ZW |
| | | FCF_ZW |
| | | GP_ZW |
| | | IE_ZW |
| | | INV_ZW |
| | | NI_ZW |
| | | OI_ZW |
| | | OPEXP_ZW |
| | | OPINC_ZW |
| | | TOTA_ZW |
| | | TOTCA_ZW |
| | | TOTCL_ADJ_ZW |
| | | TOTE_ADJ_ZW |
| | | TOTL_ZW |
| | | TOTR_ZW |
| MVA_OVERALL_E1 | Earnings | ADJNI_ZB3 |
| MVA_OVERALL_E2 | | ADJNI_ZW |
| MVA_OVERALL_E3 | | EBT_ZB3 |
| MVA_OVERALL_E4 | | EBT_ZW |
| | | GP_ADJ_ZB3 |
| | | GP_ZW |
| | | NI_TOTR_ZB3 |
| | | NI_ZW |
| | | OPINC_TOTR_ZB3 |
| | | OPINC_ZW |
| | | TOTR_ADJ_ZB3 |
| | | TOTR_ZW |
| MVA_OVERALL_D1 | Debts | IE_ZB3 |
| MVA_OVERALL_D2 | | IE_ZW |
| MVA_OVERALL_D3 | | TOTCL_ADJ_ZW |
| MVA_OVERALL_D4 | | TOTL_ADJ_ZB3 |
| | | TOTL_ZW |

The “overall” aggregate scores capture most, if not all, of the financial metrics coming from the company income statements, balance sheets and cash flow statements. Therefore, they are not restricted to one or two key drivers as X's. Instead they value all the X's and an overall view to them. It also allows them to compensate for each other. For example, a decrease in total current assets can be compensated with an increase in total assets. This type of holistic view is especially valuable when key X's of a Y are significantly changing over time (e.g., financial fraud).

The “betweens only” aggregate scores capture most, if not all, of the financial metrics coming from the company income statements, balance sheets and cash flow statements. In addition, they uniquely quantify those metrics in terms of “how similar/dissimilar the target company is compared to its peers” (see Z-between definition). Therefore, not only do they have an overall holistic view but also they are unique in capturing not the raw value but a relative value (like a distance score) for a specific target company compared to peers. This relative value makes this aggregate score valid across different industries. Therefore, this score and its like are extremely valuable in situations where the financial analyst would like to model across industries as well as have a high success rate in models that need frequent updates because of changing X's.

The “withins only” aggregate scores capture most, if not all, of the financial metrics coming from the company income statements, balance sheets and cash flow statements. In addition, they uniquely quantify those metrics in terms of trend over time (see Z-within definition). In other words, all within scores are across time periods and, therefore, these aggregate scores are across dimension and across time.

The “earnings only” aggregate scores capture only the earnings measures coming from the company income statements, balance sheets and cash flow statements.

The “debts only” aggregate scores capture debt measures coming from the company income statements, balance sheets and cash flow statements.

It should be noted that, the variables ending with 1 represent the multivariate parameters across variables indicated for the current period alone. The variables ending with 2 represent the multivariate parameters across variables indicated for the current period through prior period. Similarly, the variables ending with 3 include the current and prior 2 periods, while the variables ending with 4 include the current and prior 3 periods for each variable included in the multivariate aggregate. For example, MVA_OVERALL_E1 includes, the Z-score of the net income within the current period. The value of other parameters may be derived similarly. Those skilled in the art of financial analysis will readily understand the nomenclature of the variables above.

All these aggregate scores and their like uniquely capture across time and across dimension aspects. Moreover, they capture not raw scores but relative scores (e.g., company score relative to peers, company score relative to its past). Such variables are dynamic in nature. Not only the value of a specific metric changes from quarter to quarter but also the time intervals being considered and even the company peers automatically change over time. Because of this holistic dynamic and relative nature of these scores, they are useful in modeling Y's (e.g., fraud, financial health) that frequently change key drivers (i.e., X's) over time and across different groups (e.g., industries).

The variables (multivariate parameters) described above are examples that may be reduced to practice in capturing multivariate aggregate patterns (statistical patterns) across quarters and modified Z-scores for default prediction modeling. These parameters are based on a large number of dichotomized modified Z-scores with specified cut-offs. Thus, each multivariate aggregate, i.e., captured pattern, represents a different aspect of the company financials which prove to be important in assessing company health. In building company level default prediction models these dynamic multivariate parameters are much more important parameters than is any other financial metric that is static and univariate. Therefore, models built on multivariate parameters that capture these patterns have a stably higher predictive power than does any other alternative model that is built using the traditional parameters.

Further, the rolling averages may be calculated as part of a statistical pattern to capture the across-time and across-dimension aspects. The rolling averages maybe constructed as follows:

For T(N), AVG2 is missing,
else AVG2 = (t(i)+ t(i−1) ) / 2;
For T(N), T(N−1) T(N−2), AVG4 is missing,
else AVG4 = ( t(i) + t(i−1) + t(i−2) + t(i−3) )/4

AVG6 & AVG8 are computed analogously; where T(I-1) indicates the year/quarter immediately prior to the current year/quarter, T(I-2) indicates the year/quarter 2 periods prior to the current year/quarter, and so forth.

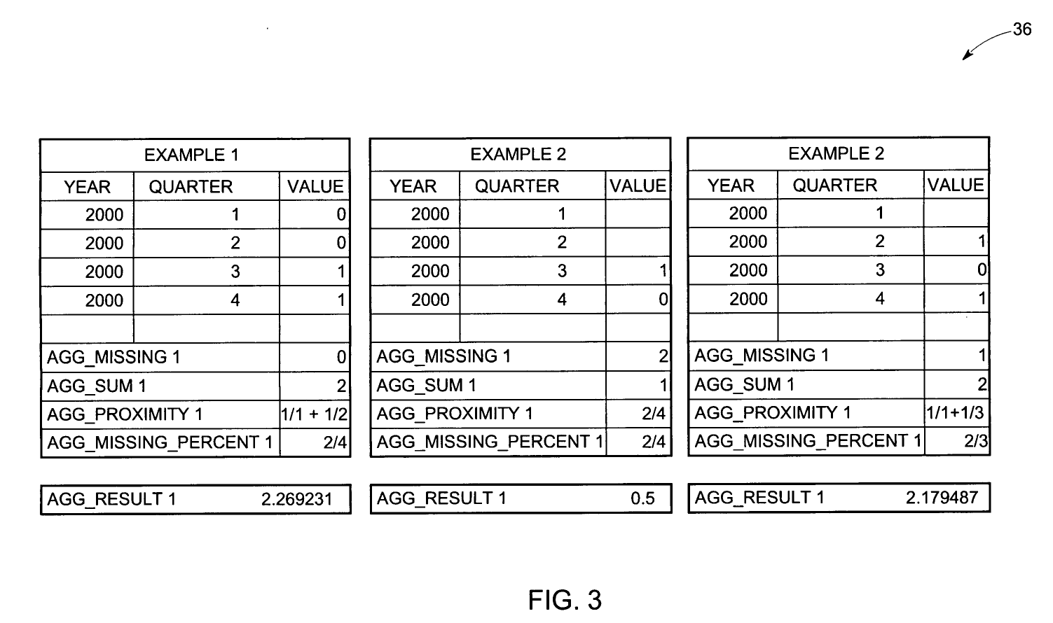

The process of computing multivariate parameters by employing control logic 30 may be demonstrated via examples 36 illustrated in FIG. 3. In the illustrated examples 36, for each multivariate parameter and for each record for the company, ordered by year and quarter, the range may be defined as the period covering the current period until the number of quarters being examined. Thus, for RF_AGGREGATE4 the range is from current period to 3 quarters back and for RF_AGGREGATE8 the range is from current period to 7 quarters back. AGG_MISSING1 is calculated as the number of quarters in that Range where the flag value is missing. AGG_SUM1 is calculated as the number of quarters in that Range where the flag value is 1. AGG_PROXIMITY is calculated as a rolling sum of 1/NumOfQuartersPrior, where NumOfQuartersPrior is calculated as the number of quarters the period is from the current quarter, i.e. 3, 2, 1 or 0 quarters back for RF_AGGREGATE4 and so forth. AGG_MISSING_PERCENT1 is calculated as “AGG_SUM1/number of non-missing quarters”. The aggregate value for that year/quarter is then calculated as:
AGG_RESULT1=AGG_SUM1+(((0.3*AGG_MISSING_PERCENT1)+(AGG_PROXIMITY1))/1.3)−1

As will be appreciated by those skilled in the art, the patterns are captured statistically over time and/or across dimensions without a limitation to the number of time periods and/or dimensions captured. The captured patterns represent the statistical quantification of interest ranging from the most common number (i.e., mode) to the variance among the measures. Further, the captured patterns are formed of measures that can either be continuous (e.g., raw financials, Z-scores) or discrete (e.g., modified Z-score categories, red flags). Moreover, the captured patterns effectively represent data with high missing percentages via increasing the number of time periods and dimensions used and employing the methods such as proportions where the denominator represents the number of non-missing cells. Additionally, the captured patterns effectively represent both analytical measures (e.g., modified Z-scores) and rule-based measures (e.g., red flags).

Further, as will be appreciated by those skilled in the art, a number of different combinations of the set of techniques described above may be used to represent statistically the patterns of interest across different parameters and different time periods. Moreover, by the nature of the proposed technique, these patterns are dynamic rather than static and may therefore be used as dynamic parameters for more sophisticated risk modeling that is more holistic with more, if not all, metrics taken into consideration, with more time periods being represented, and with all metric interactions being quantified. Thus, the multivariate dynamic representation of parameters that change over time and across dimensions enables dynamic models that better represent and predict the real world and business requirements.

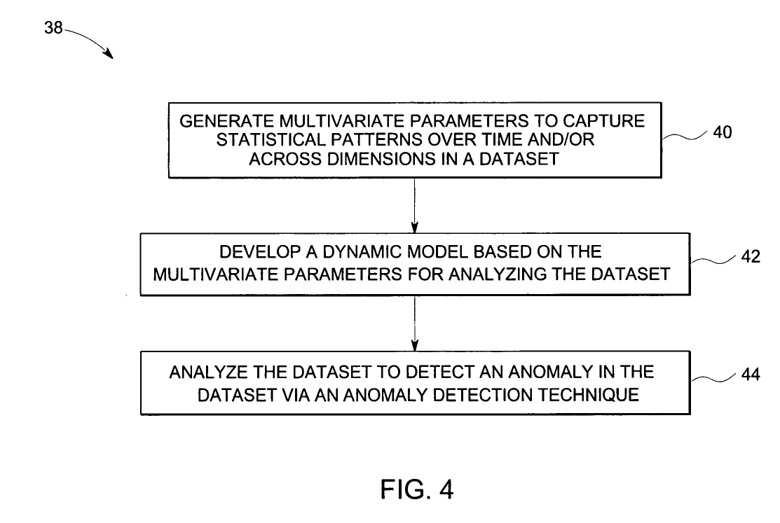

For example, referring now to FIG. 4, exemplary control logic 38 for analyzing a dataset via a data analysis system, such as computer system 10 is depicted via a flowchart in accordance with aspects of the present technique. As illustrated in the flowchart, exemplary control logic 38 includes the steps of generating multivariate parameters to capture statistical patterns over time and/or across dimensions in the dataset, as indicated at step 40, and developing a dynamic model based on the multivariate parameters for analyzing the dataset, as indicated at step 42. The statistical patterns may be indicative of analytical measures and/or rule-based measures.

In certain embodiments, the control logic 38 may further include the steps of analyzing the dataset to detect anomalous patterns in the dataset via an anomaly detection technique, as indicated at step 44. The anomaly detection techniques may include at least one of outlier detection, trend analysis, correlation analysis, regression analysis, and factor and cluster analysis. Outlier detection statistically measures whether a financial measure associated with the business entity is significantly “high” or “low.” Trend analysis may measure statistical significance in rates of change, by identifying significantly “high” or “low” increases or decreases. Correlation analysis and regression analysis may identify unusual relationships between quantitative metrics associated with the business entity. Factor and cluster analyses may classify unusual differences in financial measure groupings associated with the business entity.

The control logic 38 may also include the steps of generating an alert signal on detecting the anomaly. The alert signal may include a visual representation and/or textual representation of the detected anomaly. In certain embodiments of the present technique, the alert signal is generated based upon a degree of frequency, direction, severity or persistence of the detected anomaly. The frequency will typically represent a rate of occurrence of the detected anomaly. The direction represents a trend in the detected anomaly with respect to a population. The severity represents the amount of deviation between the detected anomaly and its population. The persistence represents a continued presence of the detected anomaly over a period of time. Color codes may be used to represent the extent and direction of deviation. Deviation in a positive or financially healthy manner, such as, for example, high cash from operations, may be represented by a green color code whereas deviation in a negative or financially unhealthy manner, such as, for example, low cash from operations, may be represented by a red color code. One of ordinary skill in the art will recognize that other color codes are possible and that other forms of generating an alert signal may be implemented in the present technique.

As will be appreciated by those skilled in the art, in certain embodiments, the control logic 38 may be employed to monitor or assess the financial health of a business entity based on the statistical patterns associated with the financial health of the business entity in accordance with aspects of the present technique. The process includes the step of acquiring patterns statistically over time and/or across dimensions. The acquired patterns represent financial data and/or business data related to the business entity. The process further includes the steps of developing a dynamic model based on the acquired patterns for analyzing financial and/or business data, and of assessing or monitoring the financial health of the business entity based on the dynamic model.

Additionally, the process may include the step of analyzing the financial data and/or business data using the financial anomaly detection technique to detect the behavioral patterns associated with the business entity. As used herein, the term “behavioral patterns” refers to one or more events or outcomes that characterize the manner in which a business entity conducts itself or responds to its environment. Examples of behavioral patterns may include misleading financials, financial statement fraud, financial decline, solid financial standings, likelihood of fraud, financial credit or investment risk and good credit or investment prospects. Those of ordinary skill in the art will recognize that the above listing of behavioral patterns is for illustrative purposes and is not meant to exclude the detection of other types of behavioral patterns by the system 30 such as, for example, leadership instability, heavy insider selling, or earnings management.

For example, in financial credit scoring, when any company financials, such as working capital or sales are used, models are no longer restricted to predicting based only on the last quarter's financial data. Time-varying parameters, such as company financials, may be captured over time via the proposed techniques. In addition, when there are many parameters of importance (high dimensionality) such as all the financial metrics from income statements, balance sheets and cash flow statements, it is no longer necessary to reduce the dimensionality by picking the top five or ten most useful parameters. This technique described in the embodiments above enables capturing all those parameters simultaneously. This pattern recognition across dimensions is of particular interest, and gives a business edge since a company's financial health can be fully characterized only by investigating all of its financials, not just a handful. Thus, the prediction models based on the above technique score a company in the same way as the auditors manually characterize a company. Even more than capturing multi-dimensional parameters across time, the technique described in the embodiments discussed above enables capturing temporal patterns where a drop in one parameter is only important when followed by a raise in another parameter.

As will be appreciated by one skilled in the art, the statistical pattern recognition technique described in the embodiments discussed above enables an efficient and complete dynamic modeling of the datasets and an efficient credit scoring and modeling of the financial datasets. Further, the set of analytical techniques that capture the multivariate dynamic patterns over time and across dimensions, as described in the various embodiments discussed above, is very flexible in application, and thus may be applied to small or large datasets, datasets with a lot of missing data points, continuous or discrete datasets, and even qualitative or quantitative datasets. As will be appreciated by one skilled in the art, the techniques described in the various embodiments discussed above can be easily generalized, thus may be applied in any field or used in any type of modeling where high dimensionality and time are important factors in quantifying the parameters. For example, the techniques described above may be applied to evaluate various datasets such as financial datasets, demographic datasets, behavioral datasets or census datasets. Additionally, by employing the techniques described in the various embodiments discussed above, the type of statistical models that can be effectively used increases from a few limited choices (e.g., time-varying coefficient survival model, time series model) to many (e.g., general linear models, discriminant function analysis, classification and regression tree (CART) analysis, neural networks, and so forth).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of capturing statistical patterns in a dataset, the method comprising:
(a) representing time-varying and/or dimension-varying data in the dataset using statistics; and
(b) deriving multivariate parameters based on the statistical data, the multivariate parameters being indicative of statistical patterns in the dataset.

2. The method of claim 1, wherein step (a) comprises representing time-varying data using moving averages, moving medians, moving quartiles, or moving standard deviations.

3. The method of claim 1, wherein step (a) comprises aggregating the dimension-varying data via central tendency, variance or Z-score.

4. The method of claim 1, wherein dimension-varying data comprises two or more metrics, red flags, rule based categorical measures, and/or discrete quantities.

5. The method of claim 1, wherein step (b) comprises computing ratio of total number of metrics that exceed the negative threshold of the modified Z-scores across the given period of time and given set of metrics to the number of non-missing Z-scores across the given period of time and given set of metrics.

6. The method of claim 1, wherein the dataset comprises a financial dataset, a demographic dataset, a behavioral dataset or a census dataset.

7. A method of analyzing a dataset, the method comprising:
generating multivariate parameters to capture statistical patterns over time and/or across dimensions in the dataset; and
developing a dynamic model based on the multivariate parameters for analyzing the dataset.

8. The method of claim 7, wherein the statistical patterns represent analytical measures and/or rule-based measures.

9. The method of claim 7, wherein the dataset comprises quantitative and/or qualitative dataset.

10. The method of claim 7, further comprising analyzing the dataset to detect an anomaly in the dataset via an anomaly detection technique.

11. The system of claim 10, wherein the anomaly detection technique comprises at least one of outlier detection, trend analysis, correlation analysis, regression analysis, and factor and cluster analysis.

12. The method of claim 10, further comprising generating an alert signal, wherein the alert signal comprises at least one of a visual representation and textual representation of the detected anomaly.

13. A method of assessing financial health of a business entity, the method comprising:
acquiring patterns statistically over time and/or across dimensions, the patterns representing financial data and/or business data related to the business entity;
developing a dynamic model based on the acquired patterns for analyzing financial and/or business data; and
assessing financial health of the business entity based on the dynamic model.

14. The method of claim 13, further comprises analyzing the financial data and/or business data using the financial anomaly detection technique to detect the behavioral patterns associated with the business entity.

15. The method of claim 14, wherein the behavioral patterns comprise at least one of likelihood of fraud, financial credit or investment risk and good credit or investment prospect associated with the business entity.

16. A system for capturing statistical patterns in a dataset, the system comprising:
a processor configured to represent time-varying and/or dimension-varying data in the dataset using statistics, and to derive multivariate parameters based on the statistical data, the multivariate parameters being indicative of statistical patterns in the dataset.

17. A data analysis system, comprising:
a processor configured to generate multivariate parameters to capture statistical patterns over time and/or across dimensions in the dataset, and to develop a dynamic model based on the multivariate parameters for analyzing the dataset.

18. The data analysis system of claim 17, wherein the processor is further configured to analyze the dataset to detect an anomaly in the dataset via an anomaly detection technique.

19. A computer readable media, comprising:
routines for representing time-varying and/or dimension-varying data in the dataset using statistics; and
routines for deriving multivariate parameters based on the statistical data, the multivariate parameters being indicative of statistical patterns in the dataset.

20. A computer readable media, comprising:
routines for generating multivariate parameters to capture statistical patterns over time and/or across dimensions in the dataset; and
routines for developing a dynamic model based on the multivariate parameters for analyzing the dataset.
